(19) United States
(12) Patent Application Publication
(10) Pub. No.: US 2014/0147108 A1
(43) Pub. Date: May 29, 2014

(54) METHOD AND APPARATUS FOR PROCESSING ALARM UNDER POWER-SAVING MODE IN PASSIVE OPTICAL NETWORK (PON) SYSTEM

(71) Applicants: Meiyan Zang, Shenzhen (CN); Yuanling He, Shenzhen (CN); Dezhi Zhang, Shenzhen (CN); Liquan Yuan, Shenzhen (CN)

(72) Inventors: Meiyan Zang, Shenzhen (CN); Yuanling He, Shenzhen (CN); Dezhi Zhang, Shenzhen (CN); Liquan Yuan, Shenzhen (CN)

(21) Appl. No.: 13/825,094

(22) PCT Filed: Feb. 25, 2011
(86) PCT No.: PCT/CN11/71320

§ 371 Date: Jun. 6, 2013

(30) Foreign Application Priority Data
Sep. 20, 2010 (CN) 201010290024.7

(51) Int. Cl. H04B 10/27

(52) U.S. Cl. CPC H04B 10/27
USPC 398/17

(57) ABSTRACT

Disclosed in the present invention are an alarm processing method and device for a PON system in power-saving mode, for solving the technical problem that the PON system cannot process the alarm or exception message after the ONU enters power-saving state and the management server is misled to deem that the system is abnormal. In the present invention, when the OLT detects the alarm generated for a certain ONU, it acquires the current power-saving working state of the ONU, and if the ONU is currently in power-saving state (such as doze state, i.e. Tx mode), the OLT suppresses, discards or shields the relevant alarm by the ONU currently in power-saving state. By way of the present invention, the alarm processing pressure can be alleviated and the real state of the ONU can be reflected.

### FIELD OF THE INVENTION

The present invention relates to the network communication interoperability field, and in particular to a method and an apparatus for processing alarm under power-saving mode in a Passive Optical Network (PON) system.

### BACKGROUND OF THE INVENTION

With the development of the broadband access technology, operators are gradually accepting and deploying the Optical Access Network (OAN) so as to serve users with higher rate and higher quality. The Passive Optical Network (PON) is a point-to-multipoint fiber access technology and consists of one or more optical line termination(s) (OLT), one or more optical network unit(s) (ONU), and an optical distribution network (ODN). The details are as shown in FIG. 1.

With gradual deployment and operation of the global PON system, the number of ONUs is also greatly increased with the increasing of the number of broadband users. Currently, the operators propose requirements regarding power-saving and emission reduction when purchasing communication equipment. In 2009, the power consumption of a single ONU is about 9 W when working in full load state, and the particular values vary with the device implementation of different manufacturers. This power consumption value has certain decline space in the future with the increasing of the integration degree of the digital chip and the optimization of part of composition optical members. Currently, the European jointly desires to reduce the power consumption by about 15% in the future two years. Therefore, the power-saving and electricity-saving of the PON devices are more and more important.

However, a series of problems may occur when the PON system works in power-saving state (sleep), for example, when entering power-saving state, an uplink irradiation module will be closed temporarily, or the uplink irradiation module and a downlink irradiation module will be closed simultaneously. After the relevant irradiation module is closed, relevant alarm for this ONU will occur, such as LOSi (Loss of the Signal) alarm, etc. If these alarms are not be processed, similar alarms will occur in the OLT alarm pool or Network Management System (NMS) alarm platform, which misleads the OLT or NMS to deem that the ONU has exception.

### SUMMARY OF THE INVENTION

In view of this, the present invention provides a method and device for processing alarm under a PON system in power-saving mode, for solving the technical problem that the PON system cannot process the alarm or exception message after the ONU enters power-saving state and the management server is misled to deem that the system is abnormal.

In order to achieve the above object, the technical solution of the present invention is implemented as follows.

A method for processing alarm under power-saving mode in a Passive Optical Network (PON) system, comprises: an Optical Line Terminal (OLT) acquiring current power-saving working state of an Optical Network Unit (ONU); and if the ONU is in power-saving state, then the OLT suppressing, discarding, or shielding alarm generated by the ONU.

Furthermore, the power-saving working state comprises power-saving state and non-power-saving state, wherein the power-saving state is doze state (Tx mode) or sleep state (TRx mode), and the alarm generated by the ONU currently in the power-saving state comprises one of the following: Loss of the Signal (LOST) alarm and dyinggasp alarm.

Furthermore, for an Ethernet Passive Optical Network (EPON) system, the OLT acquiring the power-saving working state of the ONU through an extended Operation, Administration and Management (OAM) message.

Furthermore, wherein for an Gigabit Passive Optical Network (GPON) system, the OLT acquiring the power-saving working state of the ONU through an Optical network terminal Management Control Interface (OMCI) or a Physical Layer Operation, Administration and Management (PLOAM) message.

Furthermore, the method further comprises: when the OLT detects that the ONU works in the non-power-saving state, the OLT reporting the alarm generated by the ONU to a Network Management System (NMS) server.

Based on the above method, a device for processing alarm under power-saving mode in a Passive Optical Network (PON) system, wherein the device is located at an OLT and comprises: an power-saving working state acquisition unit, configured to acquire current power-saving working state of the ONU after detecting the alarm generated by the ONU; a judgment unit, configured to judge whether the current power-saving working state of the ONU is power-saving state; and an alarm processing unit, configured to suppress, discard or shield the alarm generated by the ONU when the ONU is currently in the power-saving state.

Furthermore, the power-saving working state comprises power-saving state and non-power-saving state, wherein the power-saving state is doze state (Tx mode) or sleep state (TRx mode), and the alarm generated by the ONU currently in the power-saving state comprises one of the following: LOSi alarm and dyinggasp alarm.

Furthermore, for an Ethernet Passive Optical Network (EPON) system, the power-saving working state acquisition unit acquires the power-saving working state of the ONU through an extended Operation, Administration and Management (OAM) message. for a Gigabit Passive Optical Network (GPON) system, the power-saving working state acquisition unit acquires the power-saving working state of the ONU through Optical network terminal Management Control Interface (OMCI) or Physical Layer Operation, Administration and Management (PLOAM).

Furthermore, the device further comprises: an alarm reporting unit, configured to report the alarm generated by the ONU to a Network Management System (NMS) server when the ONU works in non-power-saving state.

Since in the solution provided by the present invention, the alarm generated by the ONU in power-saving state is shielded, the alarm processing pressure can be alleviated and the real state of the ONU can be reflected.

### BRIEF DESCRIPTION OF THE DRAWINGS

FIG. 1 is a topological structure diagram of an OLT and an ONU;

FIG. 2 is a flowchart of alarm judgment and processing when an EPON ONU works in doze mode in the present invention;

FIG. 3 is a flowchart of alarm judgment and processing when a GPON ONU works in sleep mode in the present invention; and

FIG. 4 is a structural diagram of a device for processing alarm under power-saving mode in a PON system in the present invention.

### DETAILED DESCRIPTION OF EMBODIMENTS

The basic concept of the present invention is as follows: in an power-saving mode, when an OLT detects the alarm generated by a certain ONU, it acquires current power-saving working state of the ONU, and if the ONU is currently in power-saving state, the OLT suppresses, discards or shields the relevant alarm by the ONU currently in power-saving state. The power-saving working state comprises power-saving state and non-power-saving state, wherein the power-saving state is doze state or sleep state. The doze state is that an uplink irradiation of the ONU is closed but a downlink irradiation works normally, i.e. the transmission of the ONU is closed but the reception thereof works normally, therefore, it is also referred to as Tx mode. The sleep state is that the uplink and downlink irradiation of the ONU are closed temporarily, i.e. both the transmission and reception of the ONU are closed, and therefore, it is also referred to as TRx mode.

For an EPON (Ethernet Passive Optical Network) system, the OLT acquires the power-saving working state of the ONU through an extended OAM (Operation Administration Maintenance) message; and for a GPON (Gigabit Passive Optical Network) system, the OLT acquires the current power-saving working state of the ONU through an Optical Network Terminal Management Control Interface (OMCI) or Physical Layer OAM (PLOAM). If the ONU recovers from the power-saving state to the non-power-saving state, then the OLT normally reports the relevant alarm of the ONU to the NMS server.

In order to make the object, technical solution and advantages of the present invention more clear, the present invention will be further described in detail by way of embodiments with reference to the accompanying drawings.

As shown in FIG. 1, the OLT connected to the ONU via an optical splitter, and the OLT and the ONU are managed by a NMS server as an entity.

### Embodiment 1

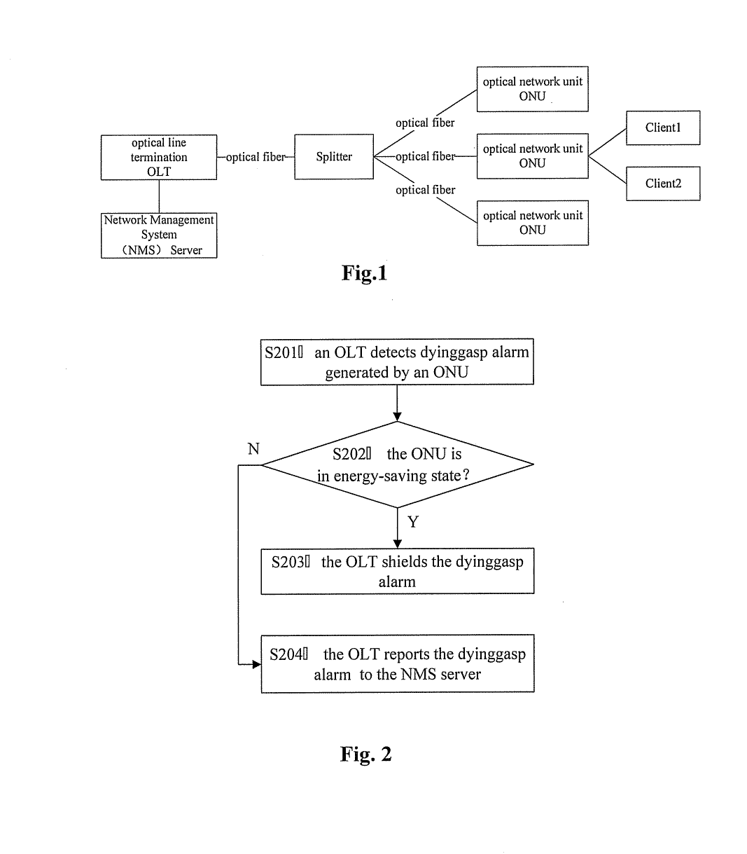

FIG. 2 is a flow of processing alarm when an ONU is under power-saving mode in a EPON system in the present invention, and the particular steps are as follows.

Step S201, an OLT detects alarm generated by a certain ONU, such as dyinggasp alarm, which alarm is used for notifying the OLT that the ONU may not be able to work normally.

Step S202, the OLT acquires whether the ONU is currently in power-saving state through an extended OAM message, and if the ONU is in power-saving state, then perform step S203, otherwise, perform step S204.

Preferably, the extended OAM message example of the current power-saving state responded by the ONU is as shown in Table 1.

TABLE 1
Message format of current power-saving state responded by ONU

| Number of | | |
|---|---|---|
| bytes | Field | Description |
| 1 | Branch (0xC7) | Identifier of Branch |
| 2 | Leaf (0x0002) | Identifier of Leaf |
| Actual | Variable Width | Data length |
| length of | | |
| data body | | |
| 1 | Current sleep mode | 0x01: doze mode (Tx) |
| | | 0x02: sleep mode (TRx) |
| | | Other value: reserved |
| | Other field | Value of other field |

Step S203, the ONU currently works in power-saving state, therefore, the OLT suppresses, discards or shields the alarm generated by the ONU.

For example, when the ONU enters into power-saving state from non-power-saving state in power-saving mode, such as sleep state (TRx mode), since the uplink and downlink irradiation of the ONU will be closed temporarily, the OLT will generate a dyinggasp alarm form the ONU, however, this does not mean the ONU itself has fault or exception, therefore, the OLT shields the dyinggasp alarm for the ONU at this moment and does not report the dyinggasp alarm to the NMS server.

Step S204, the OLT detects that the ONU works in non-power-saving state, at this moment, the alarm generated by the ONU should be that the ONU itself has fault or exception, therefore, the OLT reports the alarm generated by the ONU to the NMS server.

For example, at this moment, the dyinggasp alarm generated by the ONU detected by the OLT should be that the uplink and the downlink irradiation of the ONU has problems, therefore, the OLT has to report the dyinggasp alarm to the NMS server.

### Embodiment 2

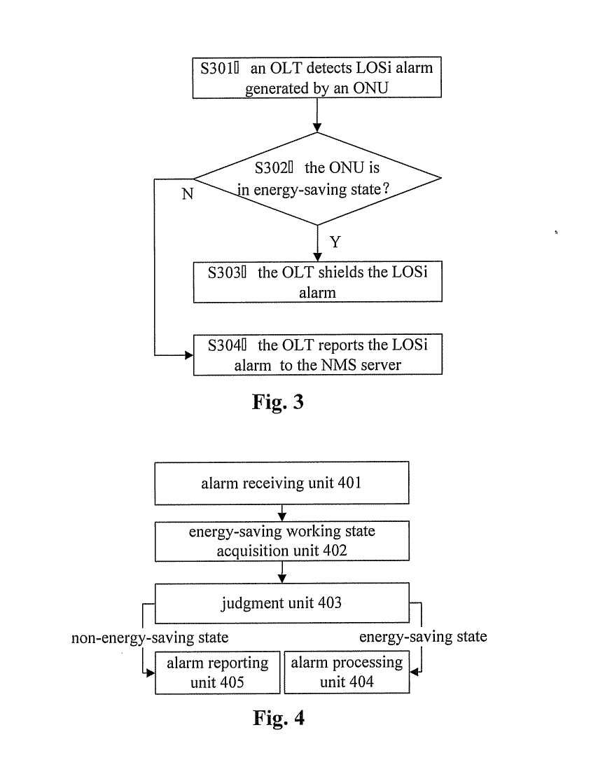

FIG. 3 is a flow of processing alarm when the ONU is under power-saving mode in the GPON system in the present invention, and the particular steps are as follows.

Step S301, the OLT detects a loss of the signal (LOSi) alarm generated form the ONU.

Step S302, the OLT detects whether the current power-saving working state of the ONU is power-saving state through an OMCI message or a PLOAM message, and if the power-saving working state of the ONU is power-saving state, such as doze state (Tx mode) or sleep state (TRx mode), then perform step S303, otherwise, perform step S304.

Step S303, the ONU currently works in power-saving state, such as doze mode (Tx mode), at this moment, since the uplink irradiation of the ONU will be closed temporarily, the OLT will generate an LOSi alarm form the ONU and the uplink irradiation of the ONU has no problem, the OLT will suppress, discard or shield the LOSi alarm generated by the ONU and will not report the LOSi alarm to the NMS server.

Step S305, the OLT detects that the ONU works in non-power-saving state, at this moment, the LOSi alarm generated by the ONU detected by the OLT should be that the ONU itself has problems, therefore, the OLT has to report the LOSi alarm to the NMS server.

### Embodiment 3

FIG. 4 is a structural diagram of an alarm processing device under power-saving mode in a PON system in the present invention, and the device is located in the OLT and comprises: an alarm receiving unit 401, an power-saving working state acquisition unit 402, a judgment unit 403, an alarm processing unit 404 and an alarm reporting unit 405.

The alarm receiving unit 401 is configured to detect alarm generated by the ONU. The power-saving working state comprises power-saving state and non-power-saving state, and the power-saving state is doze state or sleep state. The alarm generated by the ONU currently in power-saving state includes but not limited to: LOSi alarm and dyinggasp alarm.

The power-saving working state acquisition unit 402 is configured to acquire current power-saving working state of the ONU after the alarm receiving unit detects the alarm generated by the ONU. For a EPON system, the power-saving working state acquisition unit acquires the power-saving working state of the ONU through an extended OAM message, and the particular message format can be made reference to Table 1 in embodiment 1. For a GPON system, the power-saving working state acquisition unit acquires the power-saving working state of the ONU through OMCI or PLOAM.

The judgment unit 403 is configured to judge whether the current power-saving working state of the ONU is power-saving state.

The alarm processing unit 404 is configured to suppress, discard or shield the alarm generated by the ONU when the ONU is currently in the power-saving state.

The alarm reporting unit 405 is configured to report the alarm generated by the ONU to an NMS server when the ONU works in non-power-saving state.

In summary, for a PON system working in power-saving mode, relevant detection and processing are carried out on the alarm generated for an ONU by an OLT, and under proper condition, the relevant alarm is processed so as to truly reflect the state of the ONU.

The descriptions above are only the preferable embodiment of the present invention, which are not used to restrict the present invention. For those skilled in the art, the present invention may have various changes and variations. Any amendments, equivalent substitutions, improvements, etc. within the principle of the present invention are all included in the scope of the protection of the present invention.

1. A method for processing alarm under power-saving mode in a Passive Optical Network (PON) system, comprises:
an Optical Line Terminal (OLT) acquiring current power-saving working state of an Optical Network Unit (ONU); and
if the ONU is in power-saving state, then the OLT suppressing, discarding, or shielding alarm generated by the ONU.

2. The method according to claim 1, wherein the power-saving working state comprises power-saving state and non-power-saving state, wherein the power-saving state is doze state (Tx mode) or sleep state (TRx mode), and the alarm generated by the ONU currently in the power-saving state comprises one of the following: Loss of the Signal (LOSi) alarm and dyinggasp alarm.

3. The method according to claim 1, wherein for an Ethernet Passive Optical Network (EPON) system, the OLT acquiring the power-saving working state of the ONU through an extended Operation, Administration and Management (OAM) message.

4. The method according to claim 1, wherein for an Gigabit Passive Optical Network (GPON) system, the OLT acquiring the power-saving working state of the ONU through an Optical network terminal Management Control Interface (OMCI) or a Physical Layer Operation, Administration and Management (PLOAM) message.

5. The method according to claim 1, further comprises:
when the OLT detects that the ONU works in the non-power-saving state, the OLT reporting the alarm generated by the ONU to a Network Management System (NMS) server.

6. A device for processing alarm under power-saving mode in a Passive Optical Network (PON) system, located at an Optical Line Terminal (OLT), comprises:
an alarm receiving unit, configured to detect alarm generated by an Optical Network Unit (ONU);
an power-saving working state acquisition unit, configured to acquire current power-saving working state of the ONU after detecting the alarm generated by the ONU;
a judgment unit, configured to judge whether the current power-saving working state of the ONU is power-saving state; and
an alarm processing unit, configured to suppress, discard or shield the alarm generated by the ONU when the ONU is currently in the power-saving state.

7. The device according to claim 6, wherein the power-saving working state comprises power-saving state and non-power-saving state, wherein the power-saving state is doze state (Tx mode) or sleep state (TRx mode), and the alarm generated by the ONU currently in the power-saving state comprises one of the following: LOSi alarm and dyinggasp alarm.

8. The device according to claim 6, wherein for an Ethernet Passive Optical Network (EPON) system, the power-saving working state acquisition unit acquires the power-saving working state of the ONU through an extended Operation, Administration and Management (OAM) message.

9. The device according to claim 6, wherein for a Gigabit Passive Optical Network (GPON) system, the power-saving working state acquisition unit acquires the power-saving working state of the ONU through an Optical network terminal Management Control Interface (OMCI) or a Physical Layer Operation, Administration and Management (PLOAM) message.

10. The device according to claim 6, further comprises:
an alarm reporting unit, configured to report the alarm generated by the ONU to a Network Management System (NMS) server when the ONU works in non-power-saving state.

11. The method according to claim 2, wherein for an Ethernet Passive Optical Network (EPON) system, the OLT acquiring the power-saving working state of the ONU through an extended Operation, Administration and Management (OAM) message.

12. The method according to claim 2, wherein for an Gigabit Passive Optical Network (GPON) system, the OLT acquiring the power-saving working state of the ONU through an Optical network terminal Management Control Interface (OMCI) or a Physical Layer Operation, Administration and Management (PLOAM) message.

13. The method according to claim 2, further comprises:
when the OLT detects that the ONU works in the non-power-saving state, the OLT reporting the alarm generated by the ONU to a Network Management System (NMS) server.

14. The device according to claim 7, wherein for an Ethernet Passive Optical Network (EPON) system, the power-saving working state acquisition unit acquires the power-saving working state of the ONU through an extended Operation, Administration and Management (OAM) message.

15. The device according to claim 7, wherein for a Gigabit Passive Optical Network (GPON) system, the power-saving working state acquisition unit acquires the power-saving working state of the ONU through an Optical network terminal Management Control Interface (OMCI) or a Physical Layer Operation, Administration and Management (PLOAM) message.

16. The device according to claim 7, further comprises:
an alarm reporting unit, configured to report the alarm generated by the ONU to a Network Management System (NMS) server when the ONU works in non-power-saving state.
